(19) United States
(12) Patent Application Publication
(10) Pub. No.: US 2011/0285098 A1
(43) Pub. Date: Nov. 24, 2011

(54) SANITARY BARRIER FOR USE IN STORE SHOPPING CARTS

(76) Inventor: John Chris Fragale, Palm Harbor, FL (US)

(21) Appl. No.: 12/781,932

(22) Filed: May 18, 2010

(51) Int. Cl. B62B 5/08

(52) U.S. Cl. 280/33.992

(57) ABSTRACT

The present invention is a sanitization barrier or cover and its method of use for use in store shopping carts (baskets) to be placed within the child seat portion of the carts and extended to further cover the cross-handle of the cart.

### FIELD OF THE INVENTION

The invention relates to a barrier that can be inserted inside a shopping cart child seat portion for prevention of bacteria exposure to the hands, personal items, as well as any food items placed in the child seat portion.

### BACKGROUND OF THE INVENTION

More and more grocery stores and department stores are placing anti-bacteria lotions at entry ways. However, once the hands are placed on the shopping cart handle for maneuvering the basket in the store, the hands are immediately exposed again to bacteria. Similarly, children sit in the child seat portion of the cart and if they have been ill, unsanitary matter, including fecal matter or urine can be transferred to the grate and when the cart is subsequently used, that resulting bacteria can transfer to food items placed in the child seat portion or to another child who is placed in the seat.

What is needed is a method of providing a barrier that is readily available when entering the store for placement in and coverage of the child seat portion. This barrier should further extend up and over the handle portion so a user can protect his or her hands.

### SUMMARY OF THE INVENTION

The present invention is a sanitization barrier or cover and its method of use for use in store shopping carts (or also commonly called shopping baskets) to be placed within the child seat portion of the carts and extended to further cover the cross-handle used to push the cart.

The barrier comprises a generally cross-shaped flexible planar member wherein a first portion is sized to be creased and placed on top of the bottom sitting portion of a cart child seat portion that typically extends forward in the cart when used or folds back toward the handle when not in use. Extending to respective left and right sides of this first portion are respective left and right side panels that are sized to be creased near the bottom portion and each side panel has a length sufficient to extend along an adjacent exposed side portion of the shopping basket and folded and draped over the top edge of said exposed side portion.

Extending from the front side of the bottom sitting portion is an extended front panel sized to generally cover the inside back portion of the child seat. The extended front panel has a length sufficient to be folded and draped over an upper edge of the inside back portion of the child seat.

Extending from the back side of the bottom sitting panel is another extended panel sized to cover the inside of the front portion of the child seat and having a sufficient length to drape over and substantially envelope the shopping cart handle. This latter extended panel further has two spaced-apart perforated knock-out portions that can be removed or partially separated to allow a child's legs to pass through the openings on the inside front portion of the child seat.

In a preferred embodiment, each panel has near its outermost edges a portion of adhesive layer temporarily covered with a release film strip.

With this addition, the extended panel that that is sized to cover the inside back portion of the child seat can be draped over the upper edge of the inside back portion of the child seat, folded over and pressed against the back side of the extended panel for adhering to this back side. This will help secure the barrier in place on that side.

Similarly, the left and right side panels can each be folded and draped over the respective top edge of the exposed side portion and pressed against the back side of respective left and right side panels for adhering to such back side. This will help secure the barrier in place on the on the respective left and right sides of the child seat.

Further, the other extended panel sized to cover the inside of the front portion of the child seat can incorporate at its outermost edge a portion of adhesive layer temporarily covered with a release film strip. With this addition, this extended panel can be draped over the handle and adhered to its back side to secure the barrier in place on the handle side of the shopping cart.

The barrier can be made from a variety of flexible materials, including paper based materials, thin plastic/polymeric materials, anti-bacterial coated or imbedded materials, fibrous materials having anti-bacterial properties such as bamboo, and other similar materials; however, it is preferable that the material be inexpensive and readily disposable in a nearby trash container. Therefore, one typical material can be similar to the paper based material dispensed for temporarily covering toilet seats. It is also preferable that the barrier be readily available by placement in a dispensing device for dispensing in the vicinity of the area dedicated for storing and grabbing shopping carts.

A user would merely obtain a barrier from a dispensing device, spread the barrier inside the child seat portion of the shopping basket, line-up the bottom portion of the barrier over the child seat bottom portion, fold the extended side panels up along the exposed basket sides and folded it over the basket side upper edges, extend the front portion along the child seat back side and fold it over its upper edge and extend the back panel of the barrier along the child seat front portion and drape it over the basket handle. If a child is to be inserted in the basket child seat portion, the perforated knock-out portions for the legs can be partially separated at the perforation lines to allow the child's legs to be inserted in the formed opening.

### BRIEF DESCRIPTION OF THE DRAWINGS

In the accompanying drawings:

FIG. 1A is a perspective conceptual view of one embodiment of the invention placed in a representative shopping cart, also referred to herein as a shopping basket, wherein the perforations have not been separated to provide access for passing a child's legs through the resultant openings;

FIG. 1B is a perspective conceptual view of another embodiment of the invention placed in a representative shopping cart, wherein the perforations have been separated to provide access for passing a child's legs through the resultant openings;

FIG. 2 is a perspective view of a representative embodiment of the invention folded and ready for insertion in a child seat of the shopping basket;

FIG. 3 is a conceptual flat layout of one embodiment of the invention showing the additional optional knock out portions; and

FIG. 4 is a conceptual flat layout of the bottom of FIG. 3 depicting the combination adhesive covered by a release film.

### DETAILED DESCRIPTION OF THE INVENTION

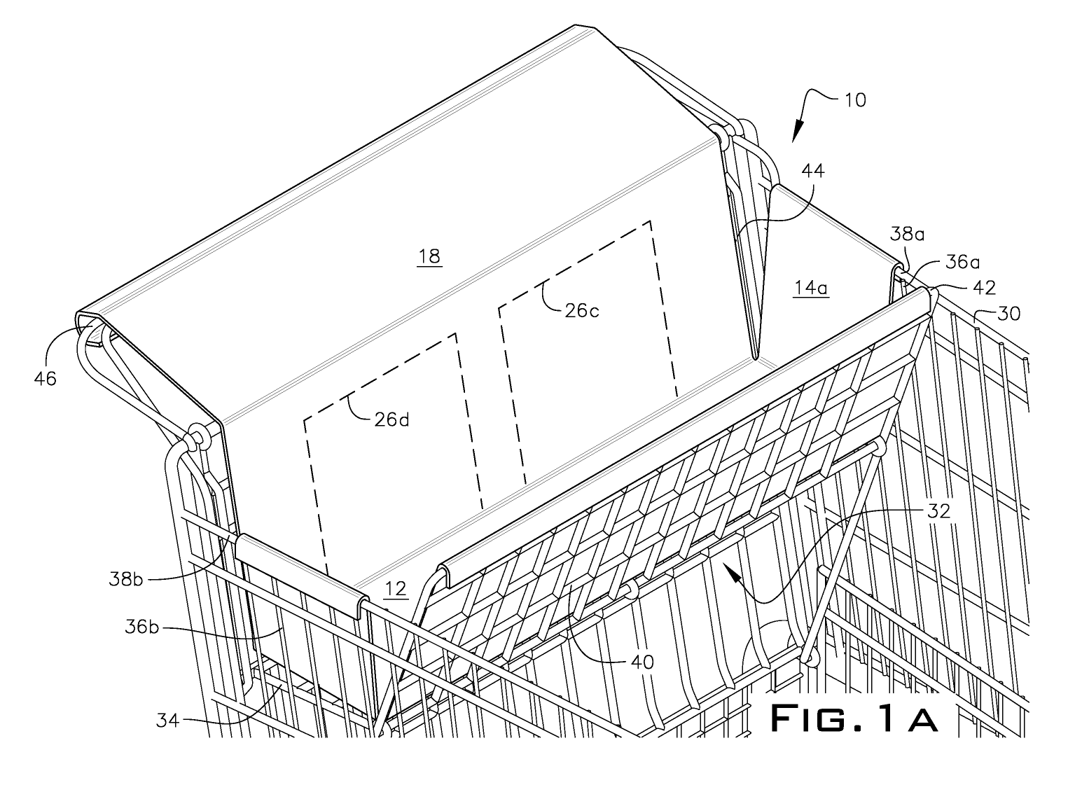

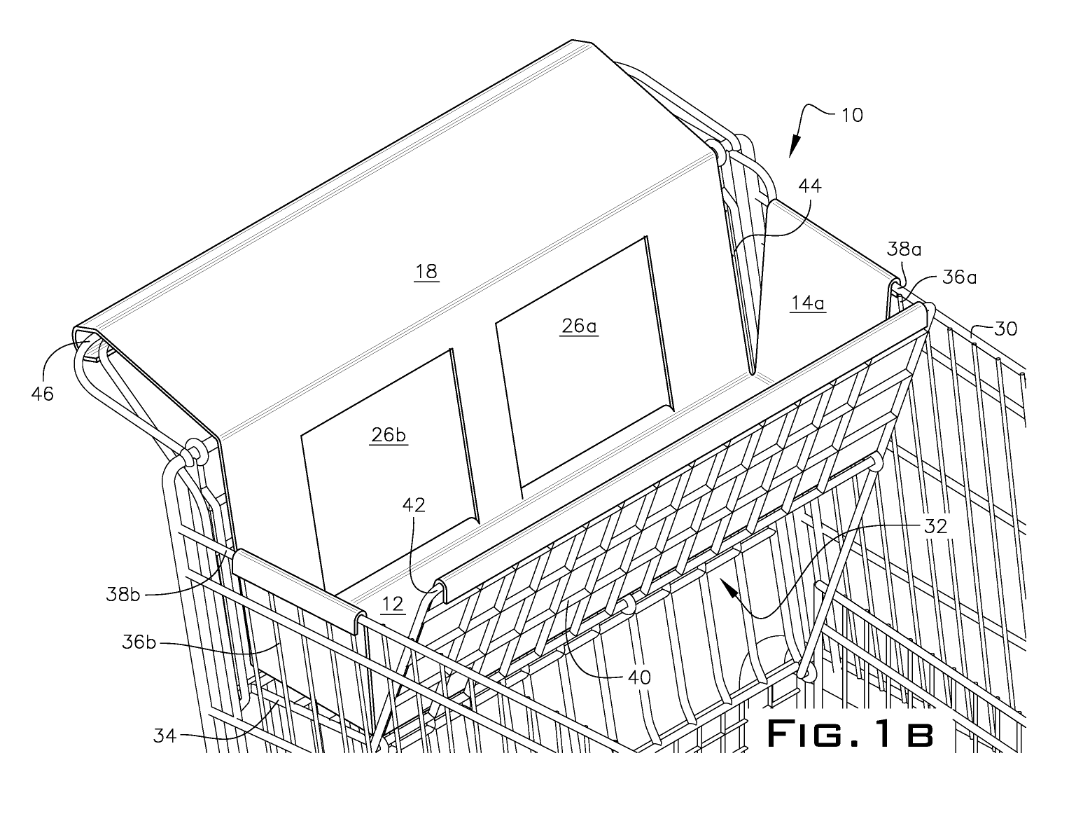

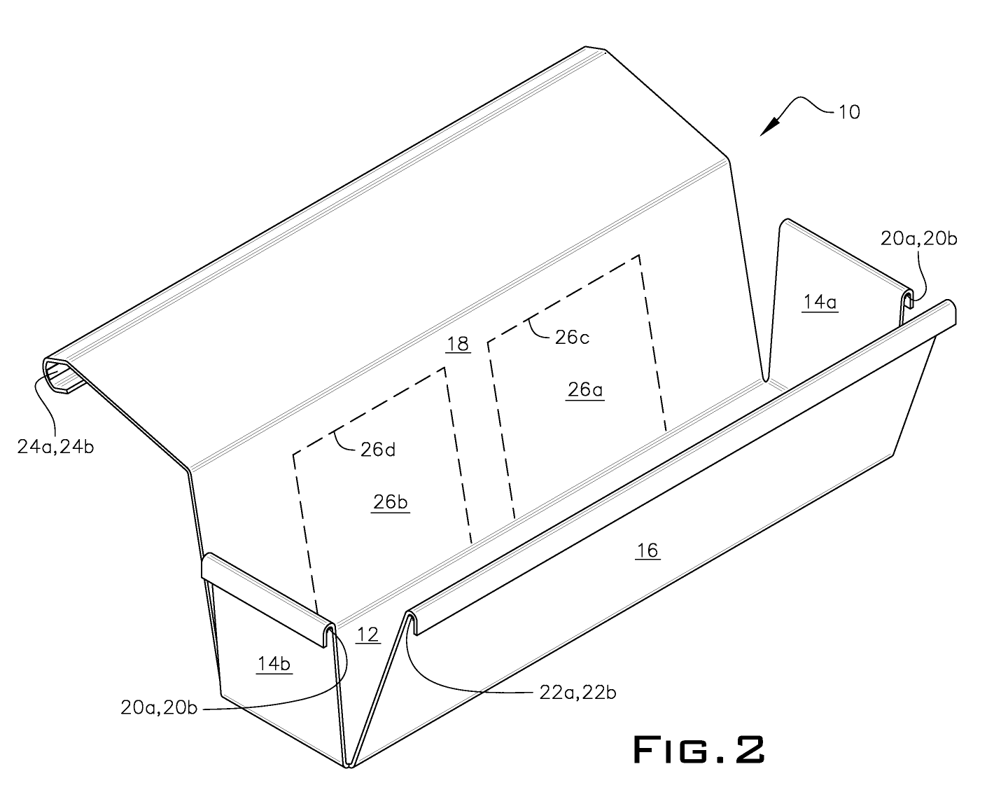

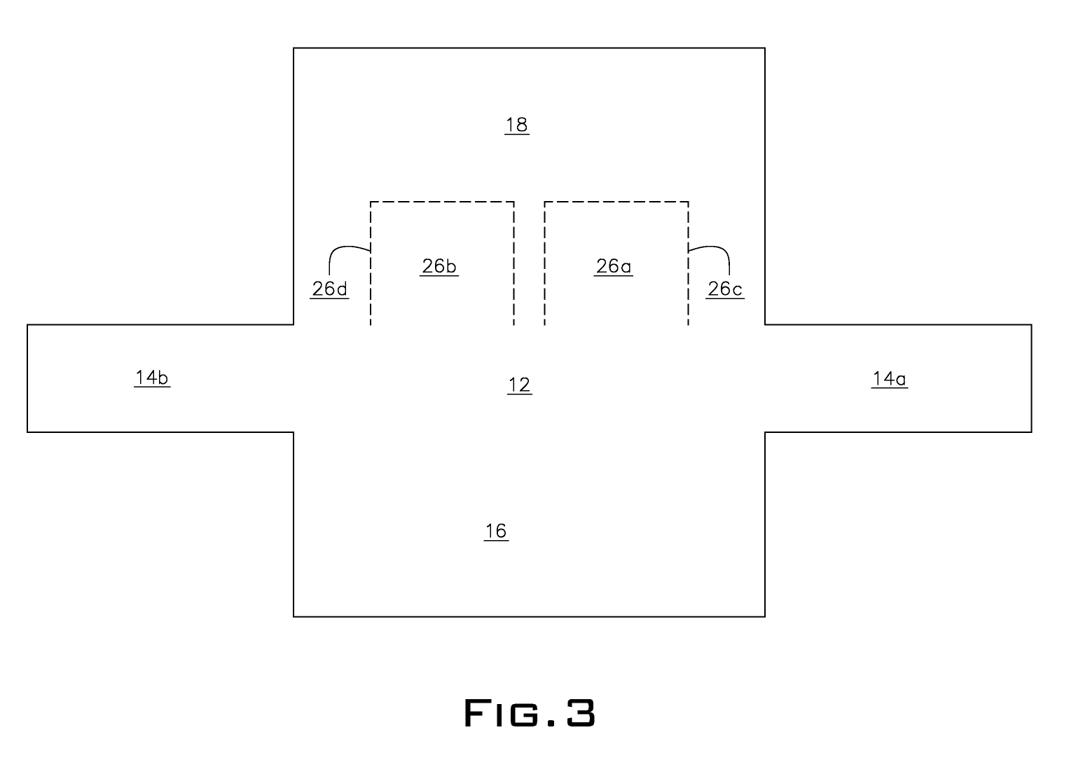

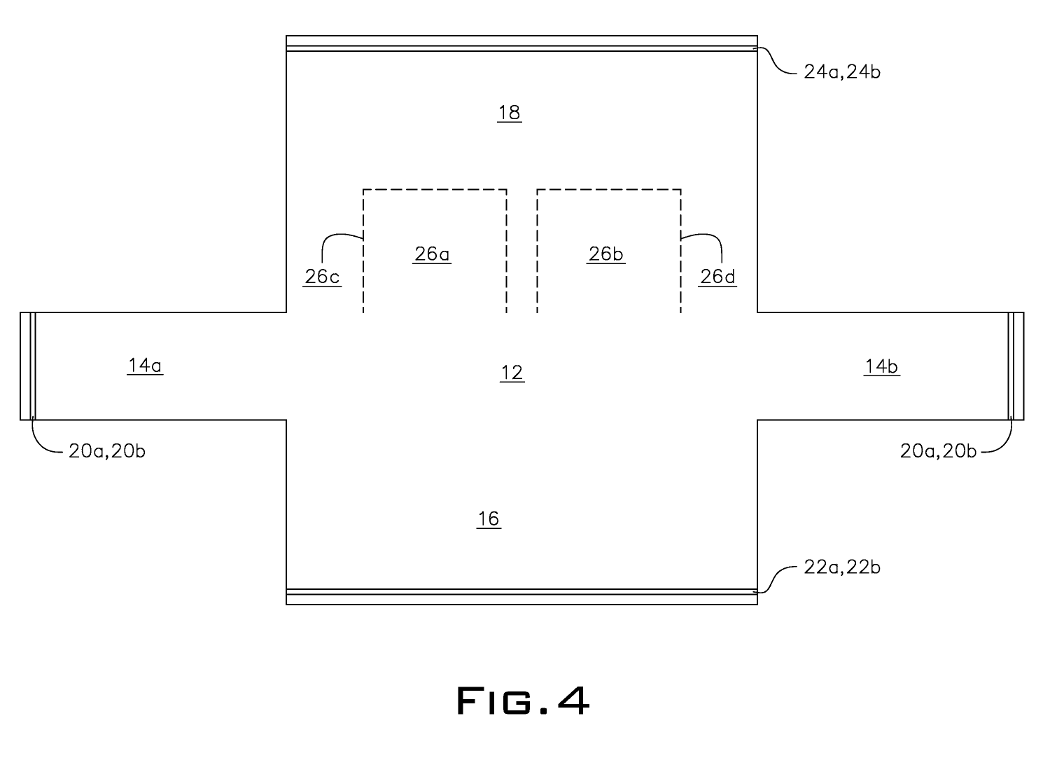

Referring now to the drawings, FIGS. 1A-1B and 2-4 disclose representative embodiments of the present invention, which is a sanitary barrier for use in the child seat portion of a store shopping cart, and is depicted generally as 10.

The sanitary barrier 10 is generally configured as a generally cross-shaped flexible planar member with a central bottom portion 12 sized to be creased and placed on top of a bottom sitting portion 34 of a child seat portion 32 of a shopping cart 30 with extended left side and right side panels 14a,14b each having a width sufficient to generally cover respective adjacent exposed side portions 36a,36b of the shopping cart 30 and a length sufficient to be folded over and draped over respective top edges 38a,38b of said respective adjacent exposed side portions 36a,36b.

Extending from a front side of the central bottom portion 12 is an extended front panel 16 which is sized to generally cover a back portion 40 of the child seat portion 32. The extended front panel 16 has a length sufficient to be folded and draped over an upper edge 42 of the back portion 40 of the child seat portion 32. Extending from a back side of the central bottom portion 12 is an extended back panel 18 which is sized to generally cover a front portion 44 of the child seat portion 32. The extended back panel 18 has a length sufficient to be folded and draped around a push handle 46 of the shopping cart 30.

The sanitary barrier 10 may further comprise an adhesive layer 20a temporarily covered with a release film strip 20b located near an outer edge of the extended left and right side panels 14a,14b. Similarly, the sanitary barrier 10 may further comprise an adhesive layer 22a temporarily covered with a release film strip 22b located near an outer edge of the extended front panel 16. Similarly, the sanitary barrier 10 may further comprise an adhesive layer 24a temporarily covered with a release film strip 24b located near an outer edge of the extended back panel 18.

When a child is to be seated in the child seat portion 32 of the shopping cart 30, the barrier 10 may further comprise two spaced-apart knock-out portions 26a,26b that are partially separated along perforation lines 26c,26d to form openings to allow a child's legs to be inserted in the formed openings.

Based on the above, one can appreciate that the method of use to protect a user or stored food items from exposure to bacteria in the child seat portion of a store shopping cart involves the providing of the above described sanitary barrier and placing the barrier within the child seat portion and covering the bottom sitting portion of the child seat portion of the shopping cart with the central bottom portion, covering the back portion of the child seat portion with the extended front panel, covering the exposed side portions of the shopping cart with the corresponding left and right side panels, and covering the front portion of the child seat portion with the extended back panel and wrapping the extended back panel around the push handle of the shopping cart.

Where the respective adhesive layers are used, the film strips can be removed and the adhesive properly engaged where appropriate. When a child is to be seated the two spaced-apart knock-out portions that are partially separated along perforation lines to form openings to allow a child's legs to be inserted in the formed openings, can be knocked-out.

It should be understood that the preceding is merely a detailed description of one or more embodiments of this invention and that numerous changes to the disclosed embodiments can be made in accordance with the disclosure herein without departing from the spirit and scope of the invention. The preceding description, therefore, is not meant to limit the scope of the invention. Rather, the scope of the invention is to be determined only by the appended claims and their equivalents.

What is claimed is:

1. A sanitary barrier for use in the child seat portion of a store shopping cart comprising:
a generally cross-shaped flexible planar member with a central bottom portion sized to be creased and placed on top of a bottom sitting portion of a child seat portion of a shopping cart with extended left and right side panels each having a width sufficient to generally cover respective adjacent exposed side portions of the shopping cart and a length sufficient to be folded over and draped over a top edge of said respective adjacent exposed side portions;
extending from a front side of the central bottom portion is an extended front panel being sized to generally cover a back portion of the child seat portion, the extended front panel having a length sufficient to be folded and draped over an upper edge of the back portion of the child seat portion; and
extending from a back side of the central bottom portion is an extended back panel being sized to generally cover a front portion of the child seat portion, the extended back panel having a length sufficient to be folded and draped around a push handle of said shopping cart.

2. The sanitary barrier according to claim 1, further comprising an adhesive layer temporarily covered with a release film strip located near an outer edge of said extended left and right side panels.

3. The sanitary barrier according to claim 1, further comprising an adhesive layer temporarily covered with a release film strip located near an outer edge of said extended front panel.

4. The sanitary barrier according to claim 1, further comprising an adhesive layer temporarily covered with a release film strip located near an outer edge of said extended back panel.

5. The sanitary barrier according to claim 1, further comprising spaced-apart knock-out portions that are partially separated along perforation lines to form openings to allow a child's legs to be inserted in said formed openings.

6. A method of creating a barrier to protect from exposure to bacteria in the child seat portion and push handle of a store shopping cart, the method comprising:
providing a sanitary barrier for use in a child seat portion of a store shopping cart, the barrier comprising:
a generally cross-shaped flexible planar member with a central bottom portion sized to be creased and placed on top of a bottom sitting portion of a child seat portion of a shopping cart with extended left and right side panels each having a width sufficient to generally cover respective adjacent exposed side portions of the shopping cart and a length sufficient to be folded over and draped over a top edge of said respective adjacent exposed side portions;
extending from a front side of the central bottom portion is an extended front panel being sized to generally cover a back portion of the child seat portion, the extended front panel having a length sufficient to be folded and draped over an upper edge of the back portion of the child seat portion; and
extending from a back side of the central bottom portion is an extended back panel being sized to generally cover a front portion of the child seat portion, the extended back panel having a length sufficient to be folded and draped around a push handle of said shopping cart; and
placing the barrier within the child seat portion and covering the bottom sitting portion of the child seat portion of the shopping cart with the central bottom portion, covering the back portion of the child seat portion with the extended front panel, covering the exposed side portions of the shopping cart with the corresponding left and right side panels, and covering the front portion of the child seat portion with the extended back panel and wrapping the extended back panel around the push handle of the shopping cart.

7. The method according to claim 6, wherein the barrier further comprises an adhesive layer temporarily covered with a release film strip located near an outer edge of said extended left and right side panels.

8. The method according to claim 6, wherein the barrier further comprises an adhesive layer temporarily covered with a release film strip located near an outer edge of said extended front panel.

9. The method according to claim 6, wherein the barrier further comprises an adhesive layer temporarily covered with a release film strip located near an outer edge of said extended back panel.

10. The method according to claim 6, wherein the barrier further comprises spaced-apart knock-out portions that are partially separated along perforation lines to form openings to allow a child's legs to be inserted in said formed openings.
